(19) United States
(12) Patent Application Publication
(10) Pub. No.: US 2022/0105821 A1
(43) Pub. Date: Apr. 7, 2022

(54) SERVICE SYSTEM, SERVICE PROVIDING METHOD, AND STORAGE MEDIUM

(71) Applicant: HONDA MOTOR CO., LTD., Tokyo (JP)

(72) Inventors: Makoto Nagai, Tokyo (JP); Yo Ito, Tokyo (JP)

(21) Appl. No.: 17/478,981

(22) Filed: Sep. 20, 2021

(30) Foreign Application Priority Data
Oct. 2, 2020 (JP) 2020-167938

(51) Int. Cl. B60L 53/62; B60L 53/64; B60L 53/10; B60W 20/20; G06Q 30/02

(52) U.S. Cl. CPC B60L 53/62; B60L 53/64; G06Q 30/0206; B60W 20/20; B60L 53/10

(57) ABSTRACT

A service system includes a service management device, which includes an authentication manager configured to manage authentication for charging of a portable battery by a charging facility on the basis of first information about the portable battery or a user using the portable battery and second information about the charging facility that charges the portable battery and a determiner configured to determine a fee to charge the portable battery in a charging service, and a service providing device configured to perform a process of providing an additional service to the user in a facility including the charging facility while the charging facility is charging the portable battery on the basis of information provided from the service management device.

### CROSS-REFERENCE TO RELATED APPLICATION

Priority is claimed on Japanese Patent Application No. 2020-167938, filed Oct. 2, 2020, the content of which is incorporated herein by reference.

### BACKGROUND OF THE INVENTION

### Field of the Invention

The present invention relates to a service system, a service providing method, and a storage medium.

### Description of Related Art

In recent years, electric vehicles such as electric vehicles (EVs) and plug-in hybrid electric vehicles (PHEVs) that travel using electric motors driven by electric power supplied from batteries have been developed. In an electric vehicle, when the battery, which is a driving source, runs out of power, it is necessary to charge the battery so that the subsequent traveling continues.

The battery is charged by a user visiting a charging facility, which is commonly used by a plurality of electric vehicles, such as a commercial facility or a charging station installed in a city. Because a certain time period is required to charge the battery in the charging facility, the user of the electric vehicle may move away from a position of the electric vehicle during charging. When the user does not return even though the charging has been completed, other electric vehicles cannot perform charging and an operating rate (a so-called turnover rate) in the charging facility decreases.

In this regard, technology for improving an operating rate in a charging facility has been disclosed (for example, see Japanese Unexamined Patent Application, First Publication No. 2020-102026). In the technology described in Japanese Unexamined Patent Application, First Publication No. 2020-102026, the turnover rate of a charging facility is increased by giving the user more incentives when the use of the charging facility is stopped at an earlier stage.

### SUMMARY OF THE INVENTION

However, in the conventional technology, because an entity for managing charging and an entity for issuing coupons are integrated, there is a high possibility that user information will be transmitted to an unintended location.

The present invention has been made on the basis of the above recognition of problems and an objective of the present invention is to provide a service system, a service providing method, and a storage medium capable of improving a protection state of user information.

A service system, a service providing method, and a storage medium according to the present invention adopt the following configurations.

(1): According to an aspect of the present invention, there is provided a service system including: a service management device, which includes an authentication manager configured to manage authentication for charging of a portable battery by a charging facility on the basis of first information about the portable battery or a user using the portable battery and second information about the charging facility that charges the portable battery, and a determiner configured to determine a fee to charge the portable battery in a charging service; and a service providing device configured to perform a process of providing an additional service to the user in a facility including the charging facility while the charging facility is charging the portable battery on the basis of information provided from the service management device.

(2): According to an aspect of the present invention, there is provided a service system including: a service management device, which includes an authentication manager configured to manage authentication for charging of a portable battery by a charging facility on the basis of first information about the portable battery or a user using the portable battery and second information about the charging facility that charges the portable battery, and a determiner configured to determine a fee to charge the portable battery in a charging service; and a service providing device configured to perform a process of providing an additional service to the user in a facility including the charging facility while the charging facility is charging the portable battery on the basis of information provided from the service management device, wherein the service management device requests the service providing device to provide third information indicating the additional service capable of being provided in response to a request from the user and provides information about the additional service to the user on the basis of the third information presented by the service providing device, and the service providing device performs a process of providing the additional service preset by the user on the basis of the information about the additional service.

(3): In the above-described aspect (1), the determiner determines a first fee as the fee if a time point when the portable battery has been removed from the charging facility is a prescribed time period earlier than a charging completion time point when the charging service for the portable battery has been completed in the charging facility or a provision completion time point when provision of the additional service has been completed, whichever is later, and, if the time point when the portable battery has been removed is the prescribed time period later than the charging completion time point or the provision completion time point, whichever is later, the determiner determines a second fee higher than the first fee as the fee.

(4): In the above-described aspect (3), when the portable battery is replaced with another portable battery that has been fully charged, the determiner determines a third fee higher than the second fee as the fee.

(5): In the above-described aspect (4), when the portable battery is replaced with the another portable battery that has been fully charged, the determiner sets the first information about the portable battery as first information about the another portable battery that has been fully charged.

(6): In the above-described aspect (1), when the authentication is completed, the service management device provides fourth information based on a part of the first information to the service providing device, and the service providing device performs a process of providing the additional service to the user on the basis of the fourth information.

(7): In the above-described aspect (6), the determiner calculates a predicted charging time period required for the charging on the basis of information of a state of charge of the portable battery included in the first information associated with the authentication that has been completed and provides the fourth information including the calculated predicted charging time period to the service providing device, the service providing device provides the additional service corresponding to the predicted charging time period included in the fourth information to the user and provides an additional service provision time period required to provide the additional service used by the user to the service management device, and the determiner determines the fee on the basis of the additional service provision time period.

(8): In the above-described aspect (7), the determiner determines a first fee as the fee if an elapsed time period from the time when the charging service for the portable battery has been completed in the charging facility to the time when the portable battery has been removed from the charging facility is less than or equal to a prescribed time period, and the determiner determines the first fee as the fee if the elapsed time period exceeds the prescribed time period, a provision start time point of the additional service indicated by the additional service provision time period is a time point before a charging completion time point when the charging service for the portable battery has been completed, and a time period obtained by subtracting the additional service provision time period from a sum of the predicted charging time period and the elapsed time period is less than or equal to the prescribed time period, and the determiner determines a second fee higher than the first fee as the fee if the elapsed time period exceeds the prescribed time period and the time period obtained in the subtraction exceeds the prescribed time period.

(9): In the above-described aspect (7), the determiner calculates the predicted charging time period on the basis of information of a destination preset by the user and information of a state of charge of the portable battery included in the first information associated with the authentication that has been completed.

(10): According to an aspect of the present invention, there is provided a service providing method including: managing, by a computer of a service management device, authentication for charging of a portable battery by a charging facility on the basis of first information about the portable battery or a user using the portable battery and second information about the charging facility that charges the portable battery and determining a fee to charge the portable battery in a charging service; and performing, by a computer of a service providing device, a process of providing an additional service to the user in a facility including the charging facility while the charging facility is charging the portable battery on the basis of information provided from the service management device.

(11): According to an aspect of the present invention, there is provided a service providing method including: managing, by a computer of a service management device, authentication for charging of a portable battery by a charging facility on the basis of first information about the portable battery or a user using the portable battery and second information about the charging facility that charges the portable battery, requesting a service providing device to provide third information indicating an additional service capable of being provided in a facility including the charging facility while the charging facility is charging the portable battery in response to a request from the user, providing information about the additional service to the user on the basis of the third information presented by the service providing device, and determining a fee to charge the portable battery in a charging service; and performing, by a computer of the service providing device, a process of providing the additional service preset by the user on the basis of the information about the additional service to the user on the basis of information provided from the service management device.

(12): According to an aspect of the present invention, there is provided a computer-readable non-transitory storage medium storing a program for causing a computer of a service management device to manage authentication for charging of a portable battery by a charging facility on the basis of first information about the portable battery or a user using the portable battery and second information about the charging facility that charges the portable battery and determine a fee to charge the portable battery in a charging service, and for causing a computer of a service providing device to perform a process of providing an additional service to the user in a facility including the charging facility while the charging facility is charging the portable battery on the basis of information provided from the service management device.

(13): According to an aspect of the present invention, there is provided a computer-readable non-transitory storage medium storing a program for causing a computer of a service management device to manage authentication for charging of a portable battery by a charging facility on the basis of first information about the portable battery or a user using the portable battery and second information about the charging facility that charges the portable battery, request a service providing device to provide third information indicating an additional service capable of being provided in a facility including the charging facility while the charging facility is charging the portable battery in response to a request from the user, provide information about the additional service to the user on the basis of the third information presented by the service providing device, and determine a fee to charge the portable battery in a charging service, and for causing a computer of the service providing device to perform a process of providing the additional service preset by the user on the basis of the information about the additional service to the user on the basis of information provided from the service management device.

According to the above-described aspects (1) to (13), it is possible to improve the protection state of user information.

### BRIEF DESCRIPTION OF THE DRAWINGS

FIG. 1 is a diagram showing an example of a configuration and a usage environment of a service system according to an embodiment.

FIG. 2 is a diagram showing an example of vehicle information in a service management device according to the embodiment.

FIG. 3 is a diagram showing an example of user information in the service management device and user information provided to the service providing device according to the embodiment.

FIG. 4 is a diagram showing an example of provision service information in the service management device according to the embodiment.

FIG. 5 is a diagram schematically showing an example of a concept when a fee is determined by the service management device according to the embodiment.

FIG. 6 is a diagram schematically showing another example of a concept when a fee is determined by the service management device according to the embodiment.

FIG. 7 is a diagram showing an example of additional service information in the service providing device according to the embodiment.

FIG. 8 is a sequence diagram showing an example of a flow of a process executed in the service system according to the embodiment.

FIG. 9 is a diagram showing an example of an information screen that presents information of additional services provided by the service management device according to the embodiment.

FIG. 10 is a diagram showing an example of an information screen when an additional service provided by the service management device according to the embodiment is used.

FIG. 11 is a sequence diagram showing an example of a flow of a process executed when charging is reserved in the service system according to the embodiment.

### DETAILED DESCRIPTION OF THE INVENTION

Hereinafter, embodiments of a service system, a service providing method, and a storage medium of the present invention will be described with reference to the drawings. As used throughout this disclosure, the singular forms “a,” “an,” and “the” include plural reference unless the context clearly dictates otherwise. The service system provides a charging service for charging a traveling battery (hereinafter simply referred to as a “battery”) that is used while mounted in a vehicle. The vehicle using the charging service is, for example, a vehicle such as a two-wheeled vehicle, a three-wheeled vehicle, or a four-wheeled vehicle. Further, the above vehicle may be a vehicle that travels according to a driving operation by the user who owns the vehicle or a so-called automated driving vehicle that travels without the need for a driving operation by the user who owns the vehicle. In the following description, it is assumed that the vehicle is a four-wheeled electric vehicle or a hybrid vehicle. The battery mounted in the vehicle may be a battery fixed to the vehicle or a portable battery that can be attached to and detached from the vehicle. Further, the battery, which is usually fixed to the vehicle, may be replaceable at a replacement facility. In the following description, it is assumed that the battery is fixed to the vehicle. That is, for example, a case in which the vehicle is parked in a parking area adjacent to the charging station and a charging cable connected to the charging station is connected to the vehicle and charges the battery will be described.

### [Usage Environment of Service System]

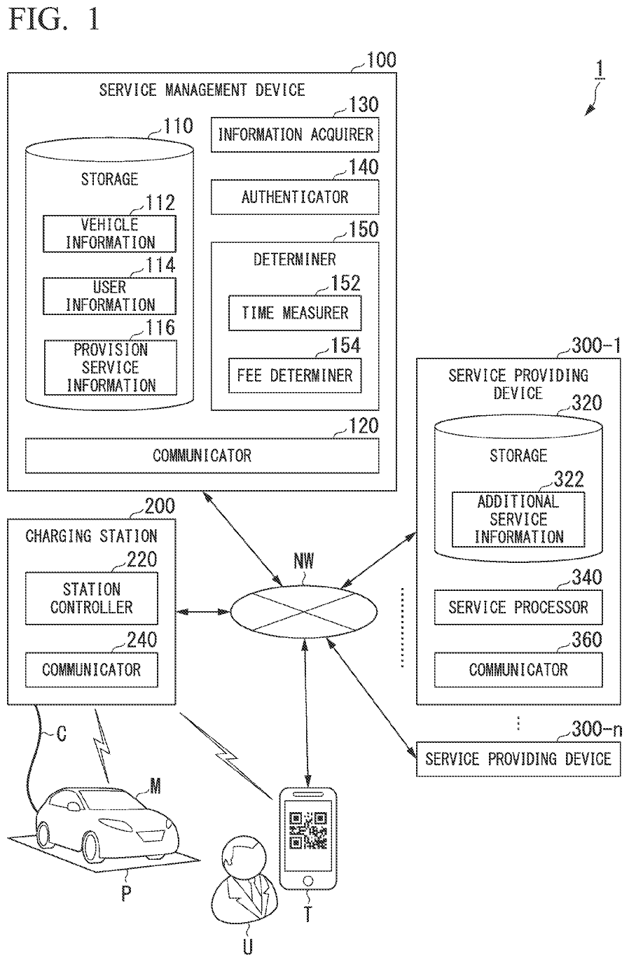

FIG. 1 is a diagram showing an example of a configuration and a usage environment of the service system according to the embodiment. A service system 1 includes, for example, a service management device 100, a charging station 200, and a service providing device 300. The service management device 100 communicates with one or more charging stations 200 and one or more service providing devices 300 via a network NW. The network NW includes, for example, the Internet, a wide area network (WAN), a local area network (LAN), a provider device, a radio base station, and the like.

The service system 1 provides a charging service for charging a battery (a secondary battery) mounted in a vehicle M at the charging station 200. The service management device 100 calculates compensation (a fee) for the charging service. The service providing device 300 provides an additional service capable of being used by a user U of the vehicle M while the battery is being charged. The additional service is an additional service such as a benefit that the user U can obtain at a facility including the charging station 200. For example, facilities including the charging station 200 are a facility in the vicinity of the charging station 200, such as a store such as a restaurant or a shop, an experience-based entertainment facility, and an amusement facility, in addition to the charging station 200. Benefits obtained by the user U include, for example, discounts on fees to charge batteries at the charging station 200 and coupons for discounts and gifts that can be used at the facility. For example, the provision of the additional service to the user U is performed by the service providing device 300 transmitting information of the additional service to a terminal device T used by the user U. The charging station 200 is an example of a “charging facility” in the claims.

The terminal device T is, for example, a portable terminal device such as a smartphone or a tablet terminal. The terminal device T performs a procedure for using the battery charging service and the provided additional service in accordance with an operation by the user U. In the terminal device T, an application or the like for using the service provided by the service system 1 may be executed. In accordance with the operation by the user U, for example, the application appropriately transmits information for requesting battery charging, selecting the additional service to be used, and using the additional service (including an advance reservation) to each of the service management device 100, the charging station 200, and the service providing device 300. The application causes a display device to display an image based on information and a notification transmitted by each of the service management device 100, the charging station 200, and the service providing device 300 or causes a speaker to enunciate audio data.

### [Configuration of Service Management Device 100]

The service management device 100 authenticates the vehicle M (which may be a battery) and the user U for charging the battery at the charging station 200 and calculates compensation (a fee) for charging the battery. The service management device 100 transmits (provides) information necessary for the service providing device 300 to provide the user U, which has been authenticated, with the additional service to the service providing device 300. The service management device 100 includes, for example, a storage 110, a communicator 120, an information acquirer 130, an authenticator 140, and a determiner 150.

Each of the information acquirer 130, the authenticator 140, and the determiner 150 is implemented, for example, by a hardware processor such as a central processing unit (CPU) executing a program (software). Some or all of the above components may be implemented by hardware (including a circuit unit: circuitry) such as a large-scale integration (LSI) circuit, an application specific integrated circuit (ASIC), a field-programmable gate array (FPGA), or a graphics processing unit (GPU) or may be implemented by software and hardware in cooperation. Some or all of the functions of the above components may be implemented by a dedicated LSI circuit. The program may be pre-stored in a storage device (a storage device including a non-transitory storage medium) such as a hard disk drive (HDD) or a flash memory provided in the service management device 100 or may be stored in a removable storage medium (a non-transitory storage medium) such as a DVD or a CD-ROM and installed in the HDD or the flash memory provided in the service management device 100 when the storage medium is mounted in a drive device provided in the service management device 100. The service management device 100 may be implemented in a server device or a storage device incorporated in a cloud computing system. In this case, a function of the service management device 100 may be implemented by a plurality of server devices and/or storage devices in the cloud computing system.

For example, vehicle information 112, user information 114, and provision service information 116 are stored in the storage 110. The above information will be described below.

The communicator 120 is a communication interface such as a network card for connecting to the network NW. The communicator 120 communicates with the service providing device 300 and/or the charging station 200 via the network NW. The communicator 120 communicates with the terminal device T via the network NW.

The information acquirer 130 performs a join acceptance process for the charging service that is provided by the service system 1 on the basis of information acquired from the terminal device T via the communicator 120. Joining the charging service in the service system 1 is also joining a service for receiving an additional service that can be used while the battery is being charged. The information acquirer 130 registers information of the user U who has performed the join acceptance process and the vehicle M used by the user U as the vehicle information 112 or the user information 114 and causes the storage 110 to store the information. The application may transmit information for performing the join acceptance process to the service management device 100 when the user U operates the application being executed in the terminal device T and inputs the information or a staff member responsible for service acceptance may register the information for performing the join acceptance process in the service management device 100 in response to the request of the user U. When the information is registered in the join acceptance process, the information acquirer 130 may separately register the vehicle information 112 and the user information 114 or register the vehicle information 112 and the user information 114 in association (together).

The information acquirer 130 may acquire information of additional services that can be provided to the user U by the service providing device 300 (for example, information similar to additional service information 322 to be described below) from the service providing device 300 via the communicator 120 and perform a process of registering the information in the storage 110. In this case, the information acquirer 130 registers additional service information obtained by associating information for identifying the service providing device 300 or the facility that provides the additional service and information of their locations in the storage 110. Thereby, in the service system 1, instead of the service providing device 300, the service management device 100 can also transmit the information about the additional service to the terminal device T.

The authenticator 140 manages authentication for charging of a battery. When the authenticator 140 has acquired information about the charging station 200 (hereinafter referred to as “charging station information”) indicating that the vehicle M has entered the charging station 200 from the charging station 200 via the communicator 120, the authenticator 140 authenticates whether or not the battery can be charged at the charging station 200. The authentication of whether or not the battery can be charged is performed on the basis of information about the vehicle M (hereinafter referred to as “charging target vehicle information”) and information about the user U (hereinafter referred to as “charging request user information”) acquired from the charging station 200 via the communicator 120 and the vehicle information 112 and the user information 114 stored in the storage 110. The authenticator 140 confirms whether or not the vehicle M included in the charging target vehicle information is a vehicle registered in the vehicle information 112 and whether or not the user U included in the charging request user information is a user registered in the user information 114. Further, the authenticator 140 confirms whether or not the user U included in the charging request user information is a user of the vehicle M included in the charging target vehicle information on the basis of the vehicle information 112 and the user information 114. When results of these confirmations indicate that it is confirmed that the user U is a correct user of the vehicle M who has joined the service system 1, the authenticator 140 authenticates that the battery of the vehicle M can be charged. The authenticator 140 outputs an authentication result to the determiner 150. The authenticator 140 is an example of an “authentication manager” in the claims. The charging target vehicle information and the charging request user information are examples of “first information” in the claims and the charging station information is an example of “second information” in the claims.

The authenticator 140 may transmit the authentication result to the charging station 200 via the communicator 120. In this case, the charging station 200 can start the charging of the battery of the vehicle M by receiving the authentication result indicating that the battery of the vehicle M can be charged from the service management device 100. Alternatively, the charging station 200 may perform an authentication process by the charging station 200 itself by performing the authentication process equivalent to that of the authenticator 140. In this case, the charging station 200 may acquire the information of the vehicle information 112 and the user information 114 registered as information of the user of the service system 1 in advance from the service management device 100, store the information in a storage (not shown), and perform the authentication process using the above information.

When the authentication result indicating that the battery of the vehicle M can be charged is input from the authenticator 140, the determiner 150 provides information for providing the additional service to the user U, which has been authenticated, to the service providing device 300 via the communicator 120 on the basis of the charging target vehicle information acquired from the charging station 200 via the communicator 120. The determiner 150 determines a fee to charge the battery on the basis of the charging target vehicle information, the charging station information, and information of a provision time period of the additional service transmitted by the service providing device 300. The determiner 150 includes, for example, a time measurer 152 and a fee determiner 154.

The time measurer 152 calculates (predicts) a time period required to charge the battery, i.e., a so-called charging time period, on the basis of a state of charge (SOC) information of the battery included in the charging target vehicle information. The time measurer 152 calculates, for example, a time period required to fully charge the battery. The charging time period calculated by the time measurer 152 is not limited to the time period required to fully charge the battery described above. For example, when the charging target vehicle information includes information of a destination to which the vehicle M is heading, the time measurer 152 may calculate the charging time period as the time period required for the vehicle M to arrive at the destination. The information about the destination is, for example, information indicating the position or the name of the destination set by the user U in a navigation device (not shown) provided in the vehicle M and includes information of whether or not another charging station 200 for charging the battery of the vehicle M is located at the destination. When another charging station 200 is located at the destination, because it is assumed that the current charging station 200 will not fully charge the battery so that charging of the battery will be executed again at the destination, the time measurer 152 calculates the charging time period for charging the vehicle M so that the vehicle M can travel to the destination.

The time measurer 152 outputs the calculated (predicted) charging time period (predicted charging time period) to the fee determiner 154. The time measurer 152 provides the service providing device 300 with additional service provider information including the calculated (predicted) charging time period (predicted charging time period) and information of a part of the user information 114 corresponding to the user U included in the charging request user information. Although the user U cannot be identified using information of a part of the user information 114, the information of the part of the user information 114 is information within a range in which the outline of the user U to whom the additional service is provided can be ascertained by the service providing device 300. The additional service provider information is an example of “fourth information” in the claims.

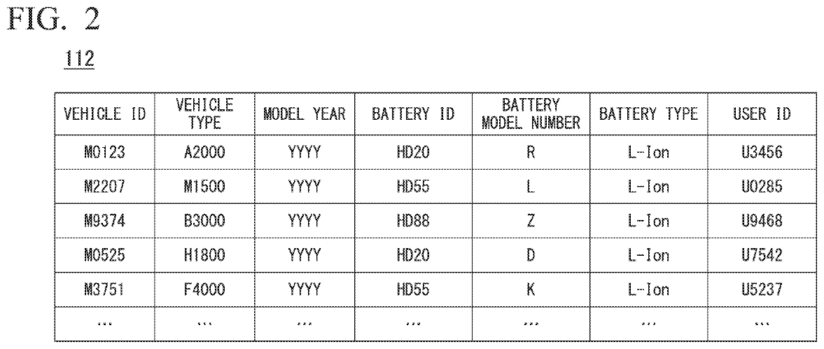

Here, an example of the vehicle information 112, the user information 114, and the additional service provider information will be described. FIG. 2 is a diagram showing an example of the vehicle information 112 in the service management device 100 according to the embodiment. The vehicle information 112 is information for identifying the vehicle and the charging target battery mounted in the vehicle. The vehicle information 112 is, for example, information in which a vehicle type, a model year, a battery ID, a battery model number, and a battery type are associated with a vehicle ID for identifying a vehicle and a user ID is further associated therewith. The vehicle type is information indicating a name, a type, a style, or the like of the vehicle. The model year is information indicating a year of manufacturing of the vehicle. The battery ID is identification information for identifying the battery mounted in the vehicle. The battery model number is information indicating a model of the battery. The battery type is information indicating a type of secondary battery constituting the battery. The user ID is identification information for identifying the user of the vehicle (which may be the owner of the vehicle). The user ID is associated with the user information 114. The vehicle information 112 is not limited to information shown in FIG. 2 and may include various information for identifying the vehicle and the charging target battery mounted in the vehicle.

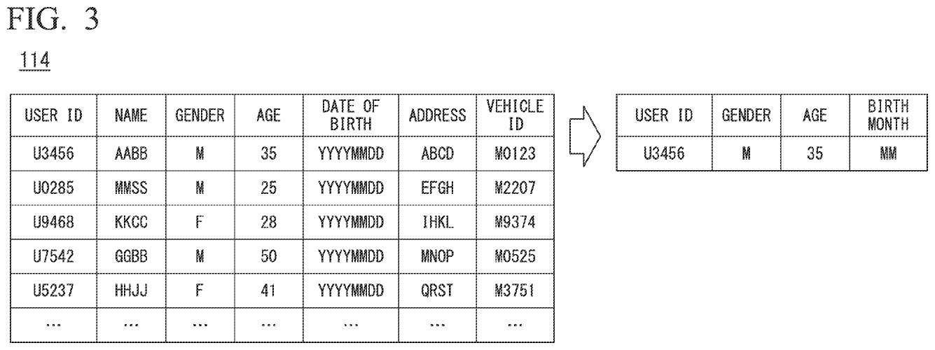

FIG. 3 is a diagram showing an example of the user information 114 in the service management device 100 and the user information provided to the service providing device 300 according to the embodiment. In FIG. 3, the example of the user information 114 is shown on the left side, and an example of additional service provider information provided by the time measurer 152 to the service providing device 300 is shown on the right side. An example of the additional service provider information of the user U at the top of the user information 114 shown on the left side is shown in FIG. 3.

The user information 114 is information for identifying a user. The user information 114 is, for example, information in which a name, a gender, an age, a date of birth, and an address are associated with a user ID for identifying the user and a vehicle ID is further associated with the user ID. Each of the name, the gender, the age, and the date of birth is the user's own information. The address is information indicating a current address of the user and the like. The vehicle ID is identification information for identifying a vehicle used or owned by the user. The vehicle ID is associated with the vehicle information 112. The user information 114 is not limited to the information shown in FIG. 3 and may include various information for identifying the user.

The additional service provider information is, for example, information in which the user ID (here, “U3456”) of the user U is associated with the gender, the age, and the birth month of the user U. The gender and the age are information extracted from the user information 114. The birth month is “month” information represented by the date of birth of the user information 114 of the user U. As the additional service provider information, information of the predicted charging time period calculated by the time measurer 152 is added to the above information.

Returning to FIG. 1, when a notification indicating that the charging of the battery at the charging station 200 has been completed is provided through the charging target vehicle information, the time measurer 152 starts the measurement of an elapsed time period until a notification indicating that the vehicle M has left a parking area P attached to the charging station 200 is provided through the charging target vehicle information. The time measurer 152 outputs information of a measured elapsed time period to the fee determiner 154.

When the notification indicating that the vehicle M has left the parking area P is provided through the charging target vehicle information, the fee determiner 154 calculates a fee to charge the battery. The fee determiner 154 determines the fee on the basis of a time relationship between the time period related to the charging of the battery included in the charging station information, the predicted charging time period output from the time measurer 152, the additional service provision time period acquired from the service providing device 300 via the communicator 120, the elapsed time period until the vehicle M has left the parking area P, and the like. For example, the fee determiner 154 determines a first fee as the fee for charging if a time point of a notification indicating that the vehicle M has left the parking area P (hereinafter referred to as a “leaving time point”) is a prescribed time period (for example, 15 minutes) earlier than a charging completion time point when the charging of the battery included in the charging station information has been completed or a provision completion time point when the provision of the additional service has been completed indicated by the additional service provision time period, whichever is later, and determines a second fee higher than the first fee as the fee for charging if the leaving time point is the prescribed time period later than the later time point. The first fee is, for example, a normal fee to charge the battery. The second fee is, for example, a fee obtained by adding an amount of money corresponding to a parking fee after the charging of the battery is completed to a normal fee. The parking fee includes the meaning of a penalty when the vehicle M has been parked in the parking area P for a time period longer than the prescribed time period.

The fee determiner 154 may determine the first fee as the fee for charging when the elapsed time period from the charging completion time point to the leaving time point is less than or equal to the prescribed time period (for example, 15 minutes) and determine the second fee as the fee for charging when the elapsed time period exceeds the prescribed time period. However, in this case, the reason why the leaving of the vehicle M from the parking area P exceeds the prescribed time period may be, for example, that the provision time period of the additional service used by the user U is longer than expected and the like and a reason different from the fact that the user U has intentionally parked for a long time period is also taken into account. Thus, the fee determiner 154 finally determines the fee to charge the battery in consideration of the additional service provision time period so that the user U who uses the additional service does not suffer any disadvantage. Thus, for example, the fee determiner 154 generates the provision service information 116 and performs management based on each time point.

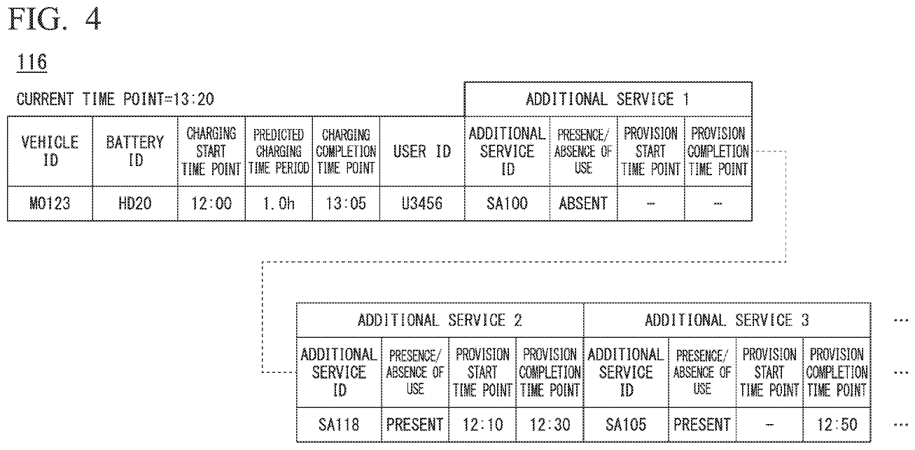

FIG. 4 is a diagram showing an example of the provision service information 116 in the service management device 100 according to the embodiment. An example of the provision service information 116 related to the user U for which the additional service provider information shown on the right side of FIG. 3 has been provided to the service providing device 300 is shown in FIG. 4. The provision service information 116 is, for example, information in which a battery ID, a charging start time point, a predicted charging time period, a charging completion time point, a user ID, and an additional service are associated with a vehicle ID. The additional service includes information of the additional service ID, the presence/absence of use, the provision start time point, and the provision completion time point. The battery ID is information extracted from the vehicle information 112. The charging start time point and the charging completion time point are information indicating a start time point and a completion time point when the charging station 200 has actually charged the battery included in the charging station information. The predicted charging time period is information indicating the charging time period calculated (predicted) by the time measurer 152. The user ID is information extracted from the user information 114. The information included in the additional service is included in the information of the additional service provision time period acquired from the service providing device 300. The additional service ID is identification information for identifying the additional service provided by the service providing device 300 to the user U. The presence/absence of use is information indicating whether or not the provided additional service has been used by the user U. The provision start time point and the provision completion time point are information indicating a start time point and a completion time point when the additional service used by the user U has been actually provided. The provision start time point may be, for example, a time point when the user U has applied for the use of the additional service, such as a time point when the user U has placed an order, and the provision completion time point may be, for example, a time point when the provision of a series of services including the additional service has been completed such as a time point when the accounting of the user U has been completed. The provision service information 116 is not limited to the information shown in FIG. 4, and a part of the information shown in FIG. 4 may be deleted or other information may be added if the information is information representing a relationship between a time period for charging the battery at the charging station 200 and an additional service provision time period.

The fee determiner 154 determines a fee when the leaving of the vehicle M from the parking area P exceeds the prescribed time period on the basis of the provision service information 116. For example, when the additional service provision start time point is earlier than the battery charging completion time point, the fee determiner 154 determines the first fee as the fee for charging if a time period obtained by subtracting a time period required for providing the additional service (a time period from the provision start time point to the provision completion time point) from a sum of the predicted charging time period and the elapsed time period is less than or equal to the prescribed time period and determines the second fee as the fee for charging if the time period obtained in the subtraction exceeds the prescribed time period. Thereby, the user U can receive the additional service with peace of mind even if a time point of the additional service provision time period is later than the time point when the battery charging has been completed. For example, when the additional service provision start time point is a time point after the battery charging completion time point, the fee determiner 154 determines the first fee as the fee for charging if the leaving time point of the vehicle M is a time point before the elapse of the prescribed time period from the charging completion time point and determines the second fee as the fee for charging if the leaving time point of the vehicle M is a time point after the elapse of the prescribed time period. Thereby, even if the time point when the charging of the battery is completed has passed, the user U can receive any additional service whose provision is completed until the prescribed time period elapses.

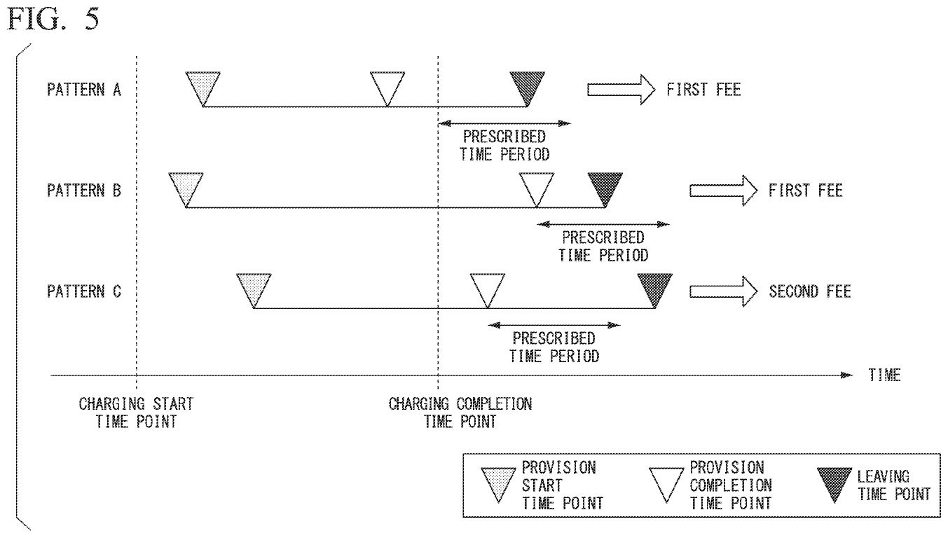

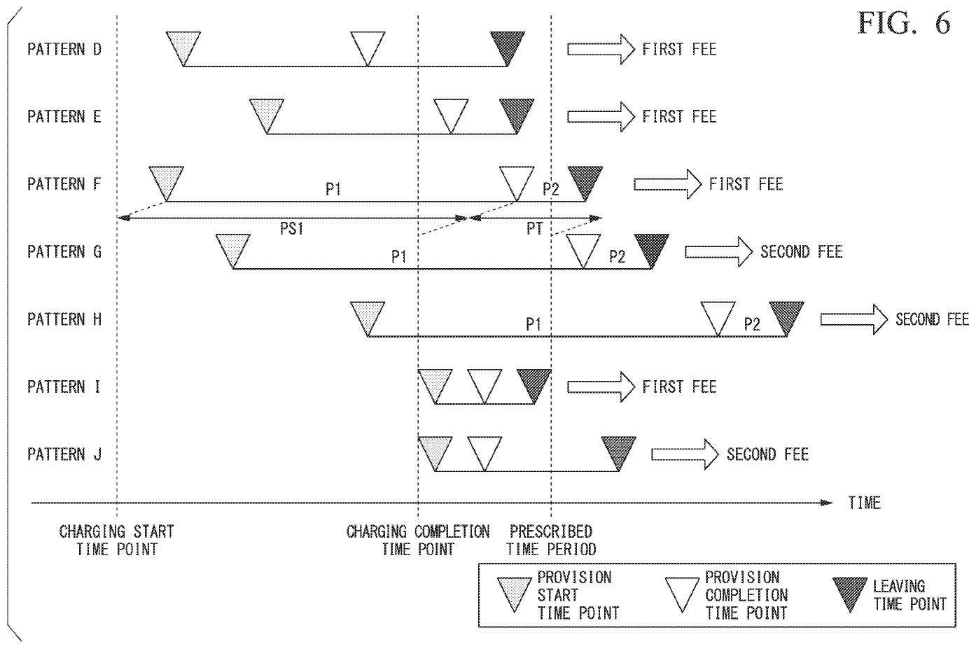

FIGS. 5 and 6 are diagrams schematically showing examples of concepts when the fee determiner 154 determines the fee in the service management device 100 according to the embodiment. The example of the concept when the fee determiner 154 determines the fee on the basis of the elapsed time period from the charging completion time point or the provision completion time point, whichever is later to the leaving time point is shown in FIG. 5 and the example of the concept when the fee determiner 154 determines the fee on the basis of the elapsed time period from the charging completion time point to the leaving time point is shown in FIG. 6. In FIGS. 5 and 6, patterns of time point relationships between the additional service provision start time point, the provision completion time point, the leaving time point of the vehicle M, and the prescribed time period are shown with respect to a time axis representing the charging start time point and the charging completion time point in the charging station 200.

First, the concept when the fee is determined on the basis of the elapsed time period from the charging completion time point or the provision completion time point, whichever is later shown in FIG. 5 to the leaving time point will be described. In pattern A, the provision completion time point is a time point before the charging completion time point. In this case, the fee determiner 154 calculates the fee on the basis of the elapsed time period from the charging completion time point. In pattern A, the leaving time point is a time point before a time point when the prescribed time period has elapsed. In this case, the fee determiner 154 determines the first fee as the fee. In pattern B, the provision completion time point is a time point after the charging completion time point. In this case, the fee determiner 154 calculates the fee on the basis of the elapsed time period from the provision completion time point. In pattern B, the leaving time point is a time point before a time point when the prescribed time period has elapsed. In this case, the fee determiner 154 determines the first fee as the fee. In pattern C, the provision completion time point is similar to that in pattern B, but the leaving time point is a time point after a time point when the prescribed time period has elapsed. In this case, the fee determiner 154 determines the second fee as the fee.

Next, the concept when the fee is determined on the basis of the elapsed time period from the charging completion time point to the leaving time point shown in FIG. 6 will be described. In pattern D, the provision start time point and the provision completion time point are within the battery charging time period (a time period from the charging start time point to the charging completion time point) and the leaving time point is a time point before the elapse of the prescribed time period. In this case, the fee determiner 154 determines the first fee as the fee. In pattern E, the provision start time point is a time point before the charging completion time point, but the provision completion time point is a time point after the charging completion time point. However, the leaving time point is a time point before the elapse of the prescribed time period. In this case, the fee determiner 154 determines the first fee as the fee. In pattern F, the provision start time point and the provision completion time point are similar to those in pattern E, but the leaving time point is a time point after the elapse of the prescribed time period. In this regard, a time period obtained by subtracting the additional service provision time period from a sum of the battery charging time period and the elapsed time period is less than or equal to the prescribed time period. In FIG. 6, a time period having the same length as an additional service provision time period P1 in pattern F is shown to compare time periods of an additional service provision time period PS1 shown on the basis of the charging start time point and a time period PT having the same length as the prescribed time period. In this case, the fee determiner 154 determines the first fee as the fee. In pattern G, relationships between the provision start time point, the provision completion time point, and the leaving time point are similar to those in pattern F. In FIG. 6, reference signs P1 and P2 that are the same as those in pattern F are shown in pattern G. In the case of pattern G, a relationship between the additional service provision time period PS1 and the time period PT is similar to that of pattern F. However, in pattern G, the time period obtained by subtracting the additional service provision time period PS1 from the sum of the battery charging time period and the elapsed time period exceeds the prescribed time period. It is considered that this is because the additional service provision start time point is later than that in pattern F, i.e., the user U tries to receive the additional service that is provided after the elapse of a certain time period. In this case, the fee determiner 154 determines the second fee as the fee. Thereby, for example, as in pattern H, it is possible to restrict the vehicle from being parked in the parking area P for a long time period at the first fee by intentionally delaying a time point for receiving the additional service.

In pattern I, the provision start time point is a time point after the charging completion time point. However, the provision completion time point and the leaving time point are time points before the elapse of the prescribed time period. That is, although the user U receives the additional service that is provided after the charging completion time point, the provision is completed until the prescribed time period elapses because the additional service is a service whose provision time period is short. In this case, the fee determiner 154 determines the first fee as the fee. In pattern J, the provision start time point and the provision completion time point are similar to those in pattern I, but the leaving time point is a time point after the elapse of the prescribed time period. That is, patent J is a pattern in which the provision of the additional service is completed until the prescribed time period elapses, but the leaving of the vehicle M by the user U is delayed. In this case, the fee determiner 154 determines the second fee as the fee.

The fee determiner 154 determines a fee to charge the battery in a concept of each pattern as shown in FIGS. 5 and 6. The patterns shown in FIGS. 5 and 6 are merely examples and various patterns in which the fee determiner 154 determines the fee can be taken into account. The method of determining the fee for each pattern in the fee determiner 154 may be an equivalent method based on a concept similar to the above-described pattern.

In this way, the fee determiner 154 determines the fee to charge the battery when the vehicle M has left the parking area P. At this time, although the fee is determined so that that the user U does not suffer any disadvantage when the user U cannot cause the vehicle M to leave the parking area P within the prescribed time period unintentionally as in the case in which the provision time period of the used additional service is longer than expected, the fee determiner 154 determines the second fee higher than the normal first fee including the meaning of a penalty as the fee when the vehicle M is parked for more than the prescribed time period. Thereby, the service system 1 can prompt the user to perform the early leaving of the vehicle M whose battery has been fully charged. In other words, it is possible to prevent a case in which another vehicle cannot charge the battery because the vehicle M does not leave the parking area P (the vehicle M is left within the parking area P for a long time period) even though the charging of the battery has been completed.

The fee determiner 154 transmits information of the determined fee to the terminal device T via the communicator 120 and notifies the user U of the information. For example, the fee determiner 154 may perform an accounting process of receiving the fee from the user U while communicating with the terminal device T or may prompt the operating company to perform the accounting process by transmitting (reporting) the fee information to a company operating the service system 1.

### [Configuration of Charging Station 200]

The charging station 200 charges a battery (a secondary battery) provided in the vehicle M which enters the parking area P attached to the charging station 200 and is connected to the charging cable C. The charging station 200 may be installed at a plurality of bases. The charging station 200 includes, for example, a station controller 220 and a communicator 240.

The station controller 220 confirms the entering of the vehicle M into the parking area P and the leaving of the vehicle M from the parking area P. For example, the confirmation of the entering and leaving of the vehicle M in the station controller 220 may be performed on the basis of a detection result of a weight sensor embedded in the parking area P or may be performed by analyzing an image from a camera photographing the parking area P. The station controller 220 may confirm the entering or leaving of the vehicle M by comparing information indicating a current location of the vehicle M acquired from a location sensor such as a global positioning system (GPS) provided in the vehicle M with a location of the parking area P.

When the charging cable C has been connected to the entering vehicle M, the station controller 220 controls, for example, the charging controller (not shown) to cause the battery to be charged. At this time, the station controller 220 acquires charging target vehicle information of the vehicle M for charging the battery and/or charging request user information of the user U who requests the charging station 200 to charge the battery and transmits the acquired information to the service management device 100. The charging target vehicle information includes, for example, information such as a battery ID given to the battery to be charged and information about a state of the battery such as an SOC. The charging target vehicle information may include information about a destination. The station controller 220 controls a charging controller (not shown) on the basis of at least the SOC of the battery and causes the battery to be charged. The acquisition of the charging target vehicle information may be performed according to short-range wireless communication with the vehicle M using, for example, Wi-Fi (registered trademark), Bluetooth (registered trademark), or the like, or may be performed according to wired communication using a signal cable attached to a power cable provided in the connected charging cable C. The charging request user information includes, for example, information for identifying the user U such as a user ID or a name given to the user U. The charging request user information is, for example, information registered in advance by the user U by operating an application. The charging request user information may include information about a destination set by the user U in the application. The acquisition of the charging request user information may be performed by the application activating a short-range wireless communication function provided in the terminal device T, such as, for example, Wi-Fi (registered trademark) or Bluetooth (registered trademark). For example, the application causes the display device of the terminal device T to display an image representing the charging request user information such as a two-dimensional bar code (so-called QR code (registered trademark)), and the user U causes a reading device provided in the charging station 200 to read the image, so that the charging request user information may be acquired. For example, the user U causes a reading device to read a card-type storage medium issued to the user U registered in advance as a user of the service system 1 for performing a charging process at the charging station 200, so that the acquisition of the charging request user information may be performed.

The station controller 220 outputs charging station information including information obtained by confirming the entering or leaving of the vehicle M, notification information indicating the start of battery charging and/or the completion of battery charging, and/or the acquired charging target vehicle information and the acquired charging request user information to the communicator 240 and causes the above information to be transmitted to the service management device 100.

The communicator 240 transmits various information output by the station controller 220 to the service management device 100 via the network NW. The communicator 240 transmits and receives information to and from the vehicle M and/or the terminal device T according to short-range wireless communication such as Wi-Fi (registered trademark) or Bluetooth (registered trademark).

### [Configuration of Service Providing Device 300]

The service providing device 300 provides the additional service on the basis of the additional service provider information transmitted (provided) by the service management device 100. For example, the service providing device 300 may be arranged in the charging station 200 or a facility in the vicinity of the charging station 200 or may be commonly arranged between facilities of the same system. The service providing device 300 includes, for example, a storage 320, a service processor 340, and a communicator 360.

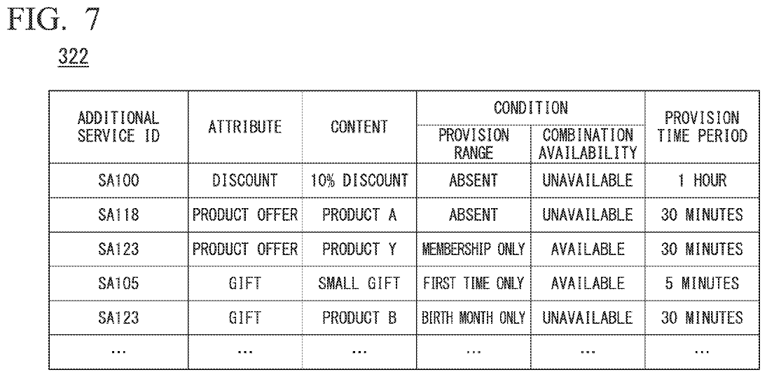

For example, the additional service information 322 is stored in the storage 320. The additional service information 322 is information about the additional service that can be provided to the user U in the service providing device 300. FIG. 7 is a diagram showing an example of the additional service information 322 in the service providing device 300 according to the embodiment. The additional service information 322 is, for example, information in which an attribute, content, a condition, and a provision time period are associated with an additional service ID for identifying an additional service. The attribute is information indicating what type of service the additional service is. In the field of the attribute, information indicating an outline of the additional service such as “discount,” “product offer,” or “gift” is described. The content is information indicating the content of the additional service. In the field of the content, information indicating a discount rate and a product name of the product to be offered or presented is described. The condition is information indicating a condition when the additional service is used. In the field of the condition, for example, a plurality of conditions for the additional service to be provided, such as “provision range” and “combination availability,” (or one condition therefore) may be described. In the field of the provision time period, information indicating a standard of a time period required to provide the additional service when the additional service is used by the user U is described. The additional service information 322 is an example of “third information” in the claims.

Returning to FIG. 1, the service processor 340 performs a process of providing the additional service to the user U. The process of providing the additional service includes, for example, a process of selecting an additional service suitable for the user U on the basis of the additional service provider information provided by the service management device 100, a process of measuring an actual time period (an additional service provision time period) required to provide the additional service to be used by the user U, and the like.

In the process of selecting the additional service, for example, the information of the user U included in the additional service provider information or an additional service matching the predicted charging time period is selected from the additional service information 322 stored in the storage 320. The service processor 340 selects, for example, an additional service whose provision is completed within the predicted charging time period, i.e., within a time period in which the battery is being charged. The service processor 340 outputs information about the selected additional service to the communicator 360 and causes the information to be transmitted to the terminal device T used by the user U. The information about the selected additional service may include information of the predicted charging time period included in the additional service provider information and information of the provision time period included in the additional service information 322.

In the process of measuring the additional service provision time period, a time point when the provision of the additional service used by the user U has been started (a provision start time point) and a time point when the provision of the additional service has been completed (a provision completion time point) are recorded. The service processor 340 outputs the information of the additional service provision time period including the recorded provision start time point and the recorded provision completion time point to the communicator 360 and causes the information to be transmitted to the service management device 100. For example, in a case in which an interval between the provision start time point and the provision completion time point is short (the provision start time point and the provision completion time point are considered to be substantially simultaneous) such as a case in which the additional service used by the user U is a small gift, the service processor 340 may record only the provision completion time point and transmit the provision completion time point to the service management device 100.

The communicator 360 transmits various information output by the service processor 340 to the service management device 100 and/or the terminal device T via the network NW.

### [Overall Process of Service System 1]

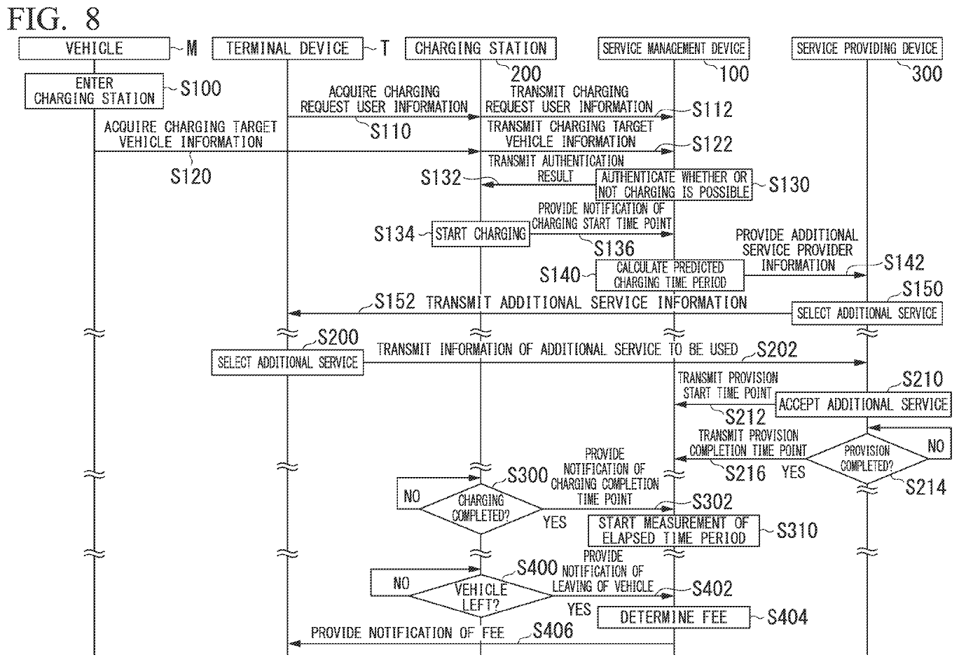

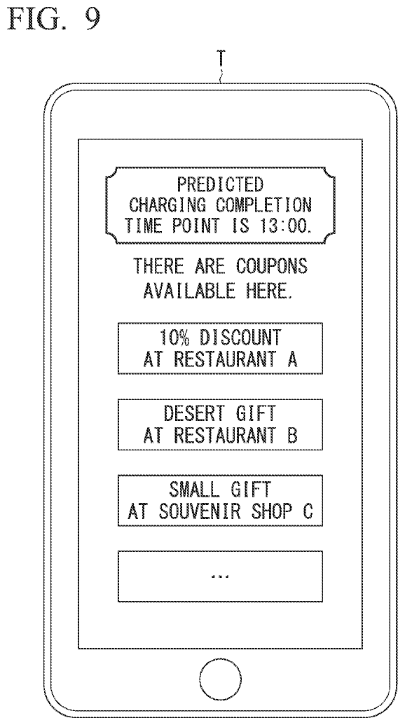

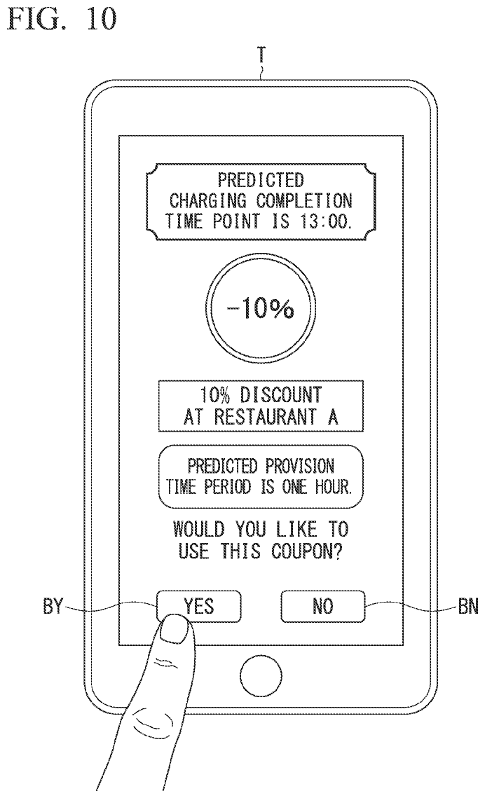

Next, an example of an overall process of the service system 1 will be described. FIG. 8 is a sequence diagram showing an example of a flow of a process executed by the service system 1 according to the embodiment. FIGS. 9 and 10 are diagrams showing examples of information screens related to the additional service provided by the service providing device 300 according to the embodiment. FIGS. 9 and 10 show examples of an image of an information screen to be displayed on the terminal device T so that the information of the additional service is presented to the user U in each situation. In the following description, the process of the service system 1 shown in FIG. 8 will be described by appropriately referring to the examples of the images of the information screens shown in FIGS. 9 and 10.

In the following description, it is assumed that the application is executed in the terminal device T and the service providing device 300 transmits the information of the additional service to the terminal device T, so that the application causes the display device of the terminal device T to display an image for presenting the additional service provided to the user U. Although the service management device 100, the charging station 200, and the service providing device 300 exchange information via the communicator and the network NW as described above in the service system 1, it is assumed that components provided in the service system 1 directly exchange information for the sake of facilitation of description.

The vehicle M enters (is parked) in the parking area P of the charging station 200 and is connected to the charging cable C and the user U performs a charging procedure at the charging station 200 (step S100). The charging procedure is, for example, a procedure in which the user U operates the terminal device T (the application) and causes charging request user information to be transmitted to the charging station 200. The above procedure may be performed before or after the user U connects the charging cable C to the vehicle M. The application executed in the terminal device T transmits the charging request user information to the charging station 200. The charging station 200 acquires the charging request user information transmitted by the terminal device T (step S110) and transmits the charging request user information to the service management device 100 (step S112). Further, the charging station 200 acquires the charging target vehicle information transmitted by the vehicle M (step S120) and transmits the charging target vehicle information to the service management device 100 (step S122).

The service management device 100 acquires the charging request user information and the charging target vehicle information transmitted by the charging station 200 and authenticates whether or not the battery of the vehicle M can be charged (step S130). Here, it is assumed that the battery of the vehicle M can be charged. The service management device 100 transmits an authentication result to the charging station 200 (step S132). The charging station 200 starts charging of the battery according to the authentication result transmitted by the service management device 100 (step S134). The charging station 200 transmits the charging station information to the service management device 100 and provides a notification of a charging start time point (step S136).

The service management device 100 calculates (predicts) a predicted charging time period (step S140). The service management device 100 transmits (provides) additional service provider information including the predicted charging time period to the service providing device 300 (step S142).

The service providing device 300 selects an additional service to be provided to the user U on the basis of the additional service provider information provided by the service management device 100 (step S150). The service providing device 300 transmits information of the selected additional service to the terminal device T (step S152). FIG. 9 shows an example of an information screen that presents information of the additional service transmitted by the service providing device 300 in step S402. As shown in FIG. 9, the terminal device T displays an image showing information of the additional service selected by the service providing device 300. In FIG. 9, an example in which a list of a plurality of additional services selected by the service providing device 300 such as a “10% discount at restaurant A” coupon, a “desert gift at restaurant B” coupon, and a “small gift at souvenir shop C” coupon is provided is shown.

Returning to FIG. 8, thereafter, the user U operates the terminal device T (the application) and performs a procedure for selecting an additional service to be used (received) (step S200). The procedure for receiving the additional service that is provided is, for example, a procedure in which the user U selects a desired additional service displayed on the terminal device T and causes information indicating the additional service to be used to be transmitted to the service providing device 300. In FIG. 10, an example of an information screen when the additional service is used in step S500 is shown. The user U selects the additional service by, for example, touching an area where information of the desired additional service is presented. An example of the information screen shown in FIG. 10 is an example in which the user U selects the “10% discount at restaurant A” coupon presented at the top of the list of additional services shown in FIG. 9. As shown in FIG. 10, the above information screen includes two selection buttons in addition to the information of the additional service. A selection button BY is a selection button when the displayed additional service is used, and a selection button BN is a selection button when the displayed additional service is not used (the selection is canceled). The user U can select whether or not to use the displayed additional service by touching the selection button of either the selection button BY or the selection button BN displayed at the bottom of the information screen. In FIG. 10, an example of a state in which the user U touches the selection button BY and selects to use the displayed additional service is shown. When the selection button BY has been touched, the terminal device T transmits information thereof to the service providing device 300 by designating the displayed additional service as an additional service to be used (step S202). On the other hand, when the selection button BN has been touched, the terminal device T returns the display to the information screen shown in FIG. 9 without transmitting the information of the displayed additional service.

Returning to FIG. 8, when the service providing device 300 receives the information of the additional service to be used from the terminal device T, the service providing device 300 accepts the provision of the additional service of the received information (step S210). The service providing device 300 records a time point when the provision of the additional service has been accepted and transmits the recorded time point serving as a provision start time point to the service management device 100 (step S212). Subsequently, the service providing device 300 confirms whether or not the provision of the received additional service has been completed (step S214). When it is confirmed that the provision of the additional service has been completed in step S214, the service providing device 300 records a time point when the provision of the additional service has been completed and transmits the recorded time point serving as a provision completion time point to the service management device 100 (step S216).

The charging station 200 notifies the service management device 100 of the charging start time point in step S206 and then confirms whether or not the charging of the battery has been completed (step S300). When it is confirmed that the charging of the battery has been completed in step S300, the charging station 200 transmits charging station information to the service management device 100 and provides a notification of the charging completion time point (step S302). Thereby, the service management device 100 starts the measurement of an elapsed time period (step S310).

Subsequently, the charging station 200 confirms whether or not the vehicle M has left the parking area P (step S400). When the leaving of the vehicle M is confirmed in step S400, the charging station 200 transmits the charging station information to the service management device 100 and provides a notification of a leaving time point of the vehicle M (step S402). Thereby, the service management device 100 determines a fee to charge the battery (step S404). The service management device 100 transmits information of the determined fee to the terminal device T and notifies the user U of the information of the determined fee (step S406).

According to the above processing flow, the service system 1 provides information of additional services that can be used by the user U while the battery of the vehicle M is being charged. At this time, the service management device 100 does not provide all of the user information 114 about the user U to the service providing device 300, but provides only a part of the information. Thereby, the service system 1 can prevent all of the user information 114 from being transmitted to the unintended service providing device 300 or the like and improve the protection state of the user information 114.

Further, in the service system 1, when the vehicle M has left the parking area P attached to the charging station 200, the fee to charge the battery is determined. At this time, in the service management device 100, even if a parking time period in the parking area P becomes longer than expected due to the use of the additional service, the fee is determined so that the user U does not suffer any disadvantage. Thereby, in the service system 1, it is possible to prevent the vehicle M from being intentionally parked in the parking area P for a long time period after the charging of the battery is completed and to improve an operating rate (a turnover rate) in the charging station 200.

As described above, according to the service system 1 of the embodiment, only a part of the user information 114 is provided to the service providing device 300 and the additional service is provided to the user U. Further, in the service system 1 of the embodiment, the fee to charge the battery is determined by consideration of the provision time period of the additional service used by the user U. Thereby, the user U can receive the additional service with peace of mind and can use the provided additional service with peace of mind while the battery is being charged.

### [Modified Example of Process of Service System 1]

In the service system 1 described above, a case in which an additional service is provided when the user U causes the vehicle M to enter the parking area P and charges the battery thereof has been described. However, a case in which the user U determines a destination in advance and plans at which charging station 200 the battery is to be charged is also taken into account. The user U may reserve charging at the charging station 200 of a planned location. In this case, if an additional service that can be used in a facility including the reserved charging station 200 is known in advance, the action during charging can be planned, which is a more preferable state for the user U. Thus, the service system 1 may be configured to provide information of additional services before the entering of the vehicle M in a case in which charging at the charging station 200 is reserved and the like. Hereinafter, an example of the above case will be described.

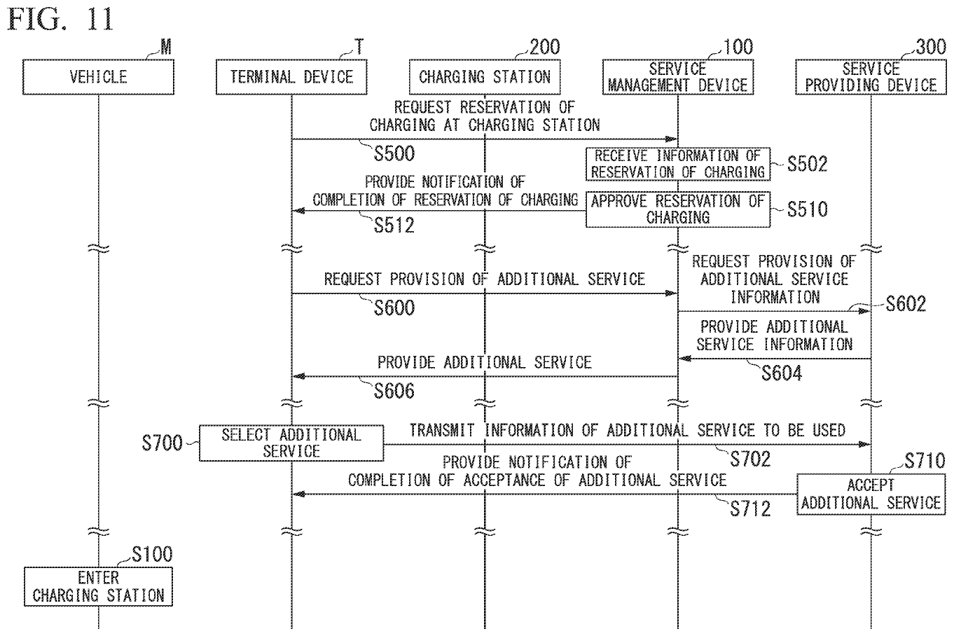

FIG. 11 is a sequence diagram showing an example of a flow of a process executed when charging is reserved in the service system according to the embodiment.

The user U operates the terminal device T (the application) and performs a request procedure for reserving battery charging at a specific charging station 200. For example, the request procedure for reserving battery charging is a procedure in which the user U selects a charging station 200 arranged on a route along which the vehicle M travels and information of the selected charging station 200 and time information such as a date and time when charging will be performed are transmitted to the service management device 100. The terminal device T transmits information necessary for the request procedure to the service management device 100 (step S500). The service management device 100 receives the information of the request procedure transmitted by the terminal device T (step S502).

When a reservation request for charging the battery is received, the service management device 100 confirms, for example, an empty state, an operating rate, and power consumption, and the like of a designated charging station 200, on the basis of information of a location of the charging station 200 and a date and time included in the information of the request procedure and approves the reservation request when charging can be performed (step S510). The service management device 100 transmits a notification indicating that the reservation procedure has been completed to the terminal device T (step S512).

Subsequently, the user U operates the terminal device T (the application) and requests the provision of information of additional services that can be used in a facility including the charging station 200 for which the reservation has been accepted. The terminal device T transmits information for requesting information of the additional services to the service management device 100 (step S600). When the service management device 100 receives the request for the information of the additional services from the terminal device T, the service management device 100 requests the service providing device 300 corresponding to the charging station 200, which has been reserved, to provide the additional service information 322 (step S602). The service providing device 300 transmits the corresponding additional service information 322 to the service management device 100 in response to the request from the service management device 100 (step S604). At this time, the service providing device 300 may be configured to transmit a part of the additional service information 322 to the service management device 100. The service management device 100 transmits the additional service information 322 acquired from the service providing device 300 to the terminal device T (step S606). Thereby, a list of additional services similar to the example of the information screen shown in FIG. 9 is displayed on the terminal device T. However, the information of the predicted charging completion time point shown in FIG. 9 is not displayed.

Subsequently, the user U operates the terminal device T (the application) and performs a procedure for selecting an additional service to be used (received) while the battery is being charged at the reserved charging station 200 (step S700). The above procedure is a procedure similar to step S200 in the entire process shown in FIG. 8. Accordingly, an information screen including a selection button similar to the example of the information screen shown in FIG. 10 is displayed on the terminal device T. The terminal device T transmits information of the additional service to be used according to an operation of the user U to the service providing device 300 (step S702).

When the service providing device 300 receives the information of the additional service to be used from the terminal device T, the service providing device 300 accepts the provision of the additional service of the received information (step S710). The service providing device 300 transmits a notification indicating that the additional service to be used has been accepted to the terminal device T (step S712).

According to the above processing flow, the service system 1 reserves charging at the charging station 200 in response to a request from the user U and also accepts a reservation for an additional service to be used by the user U.

Subsequently, the user U causes the vehicle M to enter (park) in the parking area P of the charging station 200 on a date and time of the reservation and charges a battery thereof (step S100). The subsequent process is similar to the entire process shown in FIG. 8. In this regard, a case in which the additional service to be used is reserved is equivalent to a case in which the process of selecting the additional service in the entire process shown in FIG. 8 has already been completed. Accordingly, when charging at the charging station 200 has been reserved, a part of the processes shown in FIG. 8 may not be performed. However, because the processing flow in the above case can be easily understood, a detailed description thereof will be omitted.

In the above-described embodiment, a case in which the battery to be charged is mounted in the vehicle M has been described. However, the battery used for traveling in the electric vehicle is not limited to a configuration fixed to the vehicle as described above and may be, for example, a portable battery having a configuration that can be attached to and detached from the vehicle. When the above portable battery is charged, the portable battery may be taken out of the vehicle and inserted into a battery slot or the like provided in the charging station. In this case, although the battery slot is occupied instead of the parking area P even after the charging is completed, it is only necessary for a configuration, an operation, a process, and the like of each component to be provided in the service system 1 to be equivalent to the configuration, the operation, and the process of each component when the above-described battery is mounted and fixed in the vehicle M. Thereby, even if the battery is a portable battery, an operation, and a process can be implemented as in the service system 1 described above. More specifically, the above-described “entering” of the vehicle M into the parking area P is defined as “insertion” of the portable battery into the battery slot and the above-described “leaving” from the parking area P of the vehicle M is defined as “removal” of the portable battery when the portable battery is removed from the battery slot, so that it is possible to easily implement an operation and a process similar to those of the service system 1 described above.

Further, as described above, the battery may be a replaceable battery having a configuration that can be replaced at the replacement facility. In this case, although the following process is added, a configuration, an operation, a process, and the like of each component to be provided in the service system 1 can be implemented easily on the basis of the configuration, the operation, and the process of each component when the above-described battery is mounted and fixed in the vehicle M. When the replaceable battery is replaced at the replacement facility, the vehicle M enters the replacement facility for replacing the replaceable battery instead of entering the parking area P attached to the charging station 200 and the replaceable battery mounted in the vehicle M is replaced with another replaceable battery that has already been fully charged. Thus, the service system 1 performs a process of causing information stored in the replaceable battery before replacement (for example, information corresponding to charging target vehicle information about the vehicle M equipped with the battery and charging request user information about the user U) to be stored in the (charged) replaceable battery after replacement (causing the information to be handed over thereto). Thereby, the replaceable battery after replacement can be used without any problem. For example, the above process may be performed according to an instruction issued to the replacement facility by the determiner 150 provided in the service management device 100 or may be performed by the replacement facility itself. In either case, the service system 1 updates the vehicle information 112 stored in the storage 110 from the information corresponding to the replaceable battery before replacement to the information corresponding to the replaceable battery after replacement. Further, in this case, in the service system 1, for example, the fee determiner 154 may determine a third fee higher than the second fee as the fee for charging (replacement). The third fee is equivalent to a fee when charging is completed only for a short time period required to replace the replaceable battery and is a highest fee obtained by adding an amount of money corresponding to compensation for a shortest time period because the time period (a waiting time period) required to fully charge the battery is shortest.

Further, in the battery, information about the charging service provided at the charging station or information about the additional service provided during charging may be stored in the storage provided in the battery. As the information about the service stored in the battery, for example, information at the time of charging including a charging record (which may be information at the time of replacement including a replacement record), information indicating a provided additional service or a state of use thereof, information of points given according to the use of the charging service or the additional service (including a history), and the like are taken into account. Further, as the information about the service stored in the battery, for example, information for identifying a vehicle or a user using the battery may be included. For example, information about the service stored in the battery is encrypted by the service management device or the charging station (which may be a replacement facility) according to an encryption processing program so that the information cannot be seen by an unspecified third party and stored in the battery. A function of encrypting information in the battery itself may be provided and the information encrypted by the battery itself may be stored in a storage area of a part of a storage or a dedicated storage. In the service system 1, a blockchain can be formed by components of the service management device 100, the charging station 200 (including the replacement facility), and the service providing device 300 and the information stored in the battery can be mutually referred to thereby and effectively utilized when the charging service or the additional service is provided next time. For example, when the battery is a portable battery owned by the user U, even if the portable battery charged at the charging station 200 is brought back without being mounted in the vehicle M, it is possible to provide a suitable service in a current charging service or additional service using information of a service provided at this time, in other words, information of a service provided most recently. For example, when the owner of the battery is an operating company of the service system 1 or a store or a facility that provides an additional service and the battery is shared by a plurality of vehicles or users, the owner of the battery individually ascertains the state of use of the battery or ascertains the state of use of the additional service, thereby providing a service suitable for the user. For example, when the user of the battery, which is shared, is an individual, the operating company of the service system 1 or the store or the facility, which provides the additional service, can ascertain the state of use of the charging service or the additional service for the individual user, so that the service provided to the user can be improved. For example, when the user of the battery, which is shared, is a corporation, the operating company of the service system 1 or the store or the facility, which provides the additional service, can ascertain the state of use of the charging service or the additional service for the corporation or a plurality of users belonging to the corporation, thereby providing a service suitable for the corporation or the users belonging to the corporation.

Further, the information about the service stored in the battery may include, for example, prescribed information provided to a battery user regardless of whether or not the user has joined the charging service provided by the service system 1. In this case, the battery owner can individually use (utilize) the information about the service stored in the battery even if the battery is not connected to the network.

According to the service system of the embodiment described above, there are provided the service management device 100, which includes the authenticator 140 configured to manage authentication for charging of a portable battery by the charging station 200 on the basis of charging target vehicle information and charging request user information, which are first information about the portable battery or the user U using the portable battery, and charging station information, which is second information about the charging station 200 for charging the portable battery; and the determiner 150 configured to determine a fee to charge the portable battery in a charging service; and the service providing device 300 configured to perform a process of providing an additional service to the user U in a facility including the charging station 200 while the charging station 200 is charging the portable battery on the basis of information provided from the service management device 100, whereby a protection state of the user information 114 can be improved.

The above-described embodiment can be represented as follows.

A service system including:

a service management device, which includes

a hardware processor; and

a storage device configured to store a program,

wherein the hardware processor reads and executes the program stored in the storage device to:

manage authentication for charging of a portable battery by a charging facility on the basis of first information about the portable battery or a user using the portable battery and second information about the charging facility that charges the portable battery and determine a fee to charge the portable battery in a charging service, and

a service providing device, which includes

a hardware processor; and

a storage device configured to store a program,

wherein the hardware processor reads and executes the program stored in the storage device to:

perform a process of providing an additional service to the user in a facility including the charging facility while the charging facility is charging the portable battery on the basis of information provided from the service management device.

While modes for carrying out the present invention have been described using embodiments, the present invention is not limited to such embodiments in any way and various modifications and replacements can be added without departing from the scope of the present invention.

What is claimed is:

1. A service system comprising:
a service management device, which includes
an authentication manager configured to manage authentication for charging of a portable battery by a charging facility on the basis of first information about the portable battery or a user using the portable battery and second information about the charging facility that charges the portable battery, and
a determiner configured to determine a fee to charge the portable battery in a charging service; and
a service providing device configured to perform a process of providing an additional service to the user in a facility including the charging facility while the charging facility is charging the portable battery on the basis of information provided from the service management device.

2. A service system comprising:
a service management device, which includes
an authentication manager configured to manage authentication for charging of a portable battery by a charging facility on the basis of first information about the portable battery or a user using the portable battery and second information about the charging facility that charges the portable battery, and
a determiner configured to determine a fee to charge the portable battery in a charging service; and
a service providing device configured to perform a process of providing an additional service to the user in a facility including the charging facility while the charging facility is charging the portable battery on the basis of information provided from the service management device,
wherein the service management device requests the service providing device to provide third information indicating the additional service capable of being provided in response to a request from the user and provides information about the additional service to the user on the basis of the third information presented by the service providing device, and
the service providing device performs a process of providing the additional service preset by the user on the basis of the information about the additional service.

3. The service system according to claim 1,
wherein the determiner determines a first fee as the fee if a time point when the portable battery has been removed from the charging facility is a prescribed time period earlier than a charging completion time point when the charging service for the portable battery has been completed in the charging facility or a provision completion time point when provision of the additional service has been completed, whichever is later, and
if the time point when the portable battery has been removed is the prescribed time period later than the charging completion time point or the provision completion time point, whichever is later, the determiner determines a second fee higher than the first fee as the fee.

4. The service system according to claim 3, wherein, when the portable battery is replaced with another portable battery that has been fully charged, the determiner determines a third fee higher than the second fee as the fee.

5. The service system according to claim 4, wherein, when the portable battery is replaced with the another portable battery that has been fully charged, the determiner sets the first information about the portable battery as first information about the another portable battery that has been fully charged.

6. The service system according to claim 1,
wherein, when the authentication is completed, the service management device provides fourth information based on a part of the first information to the service providing device, and
the service providing device performs a process of providing the additional service to the user on the basis of the fourth information.

7. The service system according to claim 6,
wherein the determiner calculates a predicted charging time period required for the charging on the basis of information of a state of charge of the portable battery included in the first information associated with the authentication that has been completed and provides the fourth information including the calculated predicted charging time period to the service providing device,
the service providing device provides the additional service corresponding to the predicted charging time period included in the fourth information to the user and provides an additional service provision time period required to provide the additional service used by the user to the service management device, and
the determiner determines the fee on the basis of the additional service provision time period.

8. The service system according to claim 7,
wherein the determiner determines a first fee as the fee if an elapsed time period from the time when the charging service for the portable battery has been completed in the charging facility to the time when the portable battery has been removed from the charging facility is less than or equal to a prescribed time period, and
the determiner determines the first fee as the fee if the elapsed time period exceeds the prescribed time period, a provision start time point of the additional service indicated by the additional service provision time period is a time point before a charging completion time point when the charging service for the portable battery has been completed, and a time period obtained by subtracting the additional service provision time period from a sum of the predicted charging time period and the elapsed time period is less than or equal to the prescribed time period, and
the determiner determines a second fee higher than the first fee as the fee if the elapsed time period exceeds the prescribed time period and the time period obtained in the subtraction exceeds the prescribed time period.

9. The service system according to claim 7, wherein the determiner calculates the predicted charging time period on the basis of information of a destination preset by the user and information of a state of charge of the portable battery included in the first information associated with the authentication that has been completed.

10. A service providing method comprising:
managing, by a computer of a service management device, authentication for charging of a portable battery by a charging facility on the basis of first information about the portable battery or a user using the portable battery and second information about the charging facility that charges the portable battery and determining a fee to charge the portable battery in a charging service; and
performing, by a computer of a service providing device, a process of providing an additional service to the user in a facility including the charging facility while the charging facility is charging the portable battery on the basis of information provided from the service management device.

11. A service providing method comprising:
managing, by a computer of a service management device, authentication for charging of a portable battery by a charging facility on the basis of first information about the portable battery or a user using the portable battery and second information about the charging facility that charges the portable battery, requesting a service providing device to provide third information indicating an additional service capable of being provided in a facility including the charging facility while the charging facility is charging the portable battery in response to a request from the user, providing information about the additional service to the user on the basis of the third information presented by the service providing device, and determining a fee to charge the portable battery in a charging service; and
performing, by a computer of the service providing device, a process of providing the additional service preset by the user on the basis of the information about the additional service to the user on the basis of information provided from the service management device.

12. A computer-readable non-transitory storage medium storing a program
for causing a computer of a service management device to manage authentication for charging of a portable battery by a charging facility on the basis of first information about the portable battery or a user using the portable battery and second information about the charging facility that charges the portable battery and determine a fee to charge the portable battery in a charging service, and
for causing a computer of a service providing device to perform a process of providing an additional service to the user in a facility including the charging facility while the charging facility is charging the portable battery on the basis of information provided from the service management device.

13. A computer-readable non-transitory storage medium storing a program
for causing a computer of a service management device to manage authentication for charging of a portable battery by a charging facility on the basis of first information about the portable battery or a user using the portable battery and second information about the charging facility that charges the portable battery, request a service providing device to provide third information indicating an additional service capable of being provided in a facility including the charging facility while the charging facility is charging the portable battery in response to a request from the user, provide information about the additional service to the user on the basis of the third information presented by the service providing device, and determine a fee to charge the portable battery in a charging service, and
for causing a computer of the service providing device to perform a process of providing the additional service preset by the user on the basis of the information about the additional service to the user on the basis of information provided from the service management device.
